(19) United States
(12) Patent Application Publication
(10) Pub. No.: US 2014/0222605 A1
(43) Pub. Date: Aug. 7, 2014

(54) Promoting Individual System Goals Through System Recommendations

(71) Applicant: Facebook, Inc., Menlo Park, CA (US)

(72) Inventors: Yigal Dan Rubinstein, Los Altos, CA (US); Yanxin Shi, Menlo Park, CA (US); John Hegeman, Palo Alto, CA (US)

(21) Appl. No.: 13/758,553

(22) Filed: Feb. 4, 2013

(51) Int. Cl. G06Q 30/06; G06Q 50/00; G06Q 30/08

(52) U.S. Cl. CPC G06Q 30/0631; G06Q 30/08; G06Q 50/01
USPC 705/26.3

(57) ABSTRACT

A social networking system presents recommendation units to its users. The recommendation units suggest actions for the users to increase their engagement with the social networking system or otherwise interact with other users. The social networking system establishes internal goals and associates bids for recommendation units with different goals. The bids reflect the value to the goal of a user interacting with a recommendation unit. Based on bids for recommendation units associated with one or more goals, expected values of the recommendation units arid determined. The recommendation units are ranked based on the expected values and one or more recommendation units are selected based on the ranking.

### BACKGROUND

The present disclosure generally pertains to social networking, and more particularly to providing recommendations to social networking system users.

Social networking systems enable users (including people, businesses, and other entities) to form connections and interact with other users. Social networking systems can also enrich the user experience by identifying, recording, and using the connections and interactions among the users to suggest actions or provide additional content. For example, a social networking system may infer a user's interest in a particular topic based on the user's interactions with objects related to that topic. In part, this information can also be used to select communications tailored to fit the particular interests of each user. That is, recommendations that are most relevant to a particular user's interests are presented to each user.

Social networking systems often seek to increase user interaction with the social networking system. This increased interaction allows the social networking system to obtain more information about its users or to obtain additional users. Increasing the amount of information about its users allows the social networking system to provide a better user experience with the social networking system.

A social networking system may seek to increase user engagement or increase its user base by presenting “recommendation units” to its users that identify actions within the social networking system for its users to perform. Recommendation units do not directly generate revenue for the social networking system, but they provide the social networking system with indirect benefits such as increasing user engagement or increasing the size of the social networking system user base.

Recommendation units may be generated to encourage a variety of user activities, allowing them to advance a variety of potential goals for the social networking system. However, conventional social networking systems are unable to measure effects of recommendation units on various goals of the social networking system or to efficiently allocate recommendation units for promoting different goals. For example, the social networking system may select recommendation units to advance certain goals, such as growth, user relationships, and platform features. Currently, recommendation units are evaluated using a single metric measuring the social networking system's overall interest in promoting the recommendation unit rather than in view of individual social networking system goals.

### SUMMARY

A social networking system selects recommendation units for presentation to a viewing user based on bids associated with various goals of the social networking system. Goals of the social networking system may include types of interactions by users that the social networking system seeks to encourage. Examples of goals include user growth, user retention, user engagement, and page promotion. Each goal may be associated with bids on particular recommendation unit types used for selecting recommendation units to users matching targeting criteria of one or more bids.

When a viewing user accesses a page of the social networking system, the social networking system provides suggestion content that includes recommendation units. To select a recommendation unit for the viewing user, bids associated with recommendation units by one or more goals are accessed and compared with a user profile associated with the viewing user. Recommendation units associated with targeting criteria satisfied by information in the user profile are identified as candidate recommendation units for the viewing user. Bids for each candidate recommendation unit are retrieved and bids for a candidate recommendation unit associated with one or more goals are combined to determine an expected value for the candidate recommendation unit. As multiple goals may be associated with bids on a recommendation unit, various goals may be advanced by presenting a recommendation unit. Based on the combined bids associated with the candidate recommendation units, one or more candidate recommendation units are selected. For example, the combined bids are ranked and the ranking is used to select one or more recommendation units, which are populate with information specific to the viewing user and presented to the viewing user.

The social networking system may display content to a viewing user that includes a combination of recommendation units and advertisements. In one embodiment, the advertisements directly compete with the recommendation units in the auction. This allows individual social networking system goals to be individually budgeted and managed through the recommendation units, while selecting recommendation units for presentation based on the value of the recommendation units to their associated goals.

### BRIEF DESCRIPTION OF THE DRAWINGS

FIG. 1 is a diagram illustrating selection and presentation of content to a user by a social networking system, in accordance with an embodiment of the invention.

FIG. 2 is a diagram illustrating goal-specific bids for recommendation unit types according to one embodiment.

FIG. 3 is a diagram illustrating recommendation unit selection using goal-specific bids to select recommendation units according to an embodiment.

FIG. 4 is a high level block diagram of a system environment for providing content items to users of a social networking system, in accordance with an embodiment of the invention.

FIG. 5 is a block diagram of a system architecture of a social network, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Content Presented to Social Networking System Users

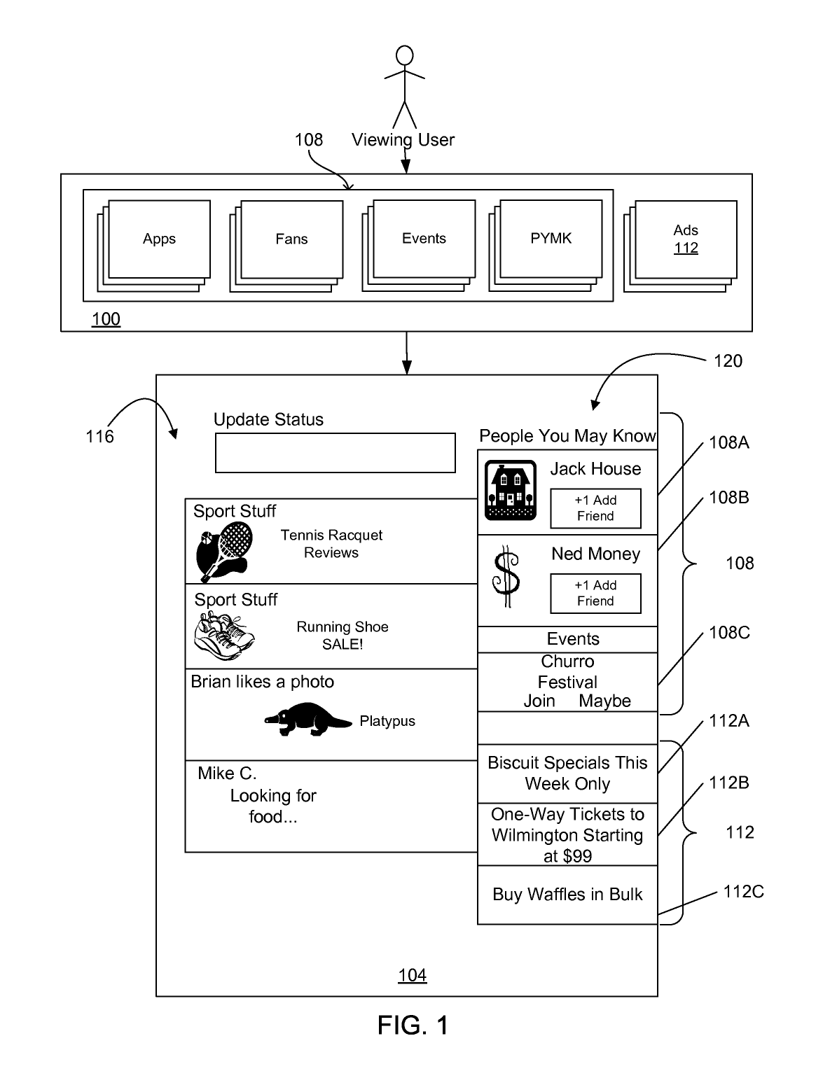

FIG. 1 shows an example of a social networking system 100 that provides content to a viewing user of the social networking system 100. In the example shown by FIG. 1, the social networking system 100 provides narrative content 116 and suggestion content 120 to the viewing user. In the example of FIG. 1, the narrative content 116 and the suggestion content 120 are presented in separate regions of a display 104. However, in other embodiments, the narrative content 116 and the suggestion content 120 may be combined or may be organized in the display 104 differently than the example shown in FIG. 1.

The narrative content 116 describes actions taken by other users of the social networking system 100 that are connected to the viewing user. Examples of content included in the narrative content 116 include news stories, media provided to the social networking system 100 (e.g., pictures or videos), status messages of other users of the social networking system, links posted by users to the social networking system, events, plans, groups, pages (e.g., representing an organization or entity), or other content provided by or accessible via the social networking system. In one embodiment, the narrative content 116 is a news feed including stories describing actions taken by other social networking system users connected to the viewing user, a status of social networking system users connected to the viewing user, events in the social networking system 100, content posted by other social networking systems, or similar data. In addition to presenting the narrative content 116, the social networking system 100 may also receive data from the viewing user for inclusion in the narrative content presented to other users.

Additionally, the narrative content 116 may display information from a user profile associated with the viewing user. For example, the narrative content 116 displays actions taken by the viewing user, demographic information about the viewing user, photographs or other media associated with the viewing user, interests about the viewing user, or other data describing attributes of the viewing user.

The suggestion content 120 includes content items suggesting actions for the viewing user to perform and/or content with which the viewing user may interact; the social networking system 100 selects the content included in the suggestion content 120. In one embodiment, content items in the suggestion content 120 are one or more recommendation units 108 and one or more advertisements 112. A recommendation unit 108 suggests an action for the viewing user to perform that increases the viewing user's interaction with the social networking system 100. For example, a recommendation unit 108 suggests other users of the social networking system 100 with which the viewing user may establish a connection and includes a link for connecting the viewing user to a suggested user. In FIG. 1, recommendation units 108A, 108B illustrate suggestions for connecting the viewing user with other users. As another example, a recommendation unit 108 identifies an event for the viewing user to attend, such as recommendation unit 108C in FIG. 1. Other examples of the recommendation units 108 identify applications for the viewing user to use or download, identify one or more groups of users for the viewing user to join, identify users of the social networking system for whom the viewing user may express a preference, suggest the viewing user invite additional individuals or entities to join the social networking system 100, provide gifts that the viewing user may give to other users, show fan pages that the viewing user may join, other items that may be interesting to the user, or any other suitable action increasing interaction between the viewing user and the social networking system 100.

Hence, the recommendation units 108 suggest actions for the viewing user that increase the engagement with the social networking system 100 or allow the social networking system 100 to interact with more users. This allows the social networking system 100 to obtain additional information about the viewing user or increase the number of users of the social networking system. Each recommendation unit promotes one or more goals of the social networking system 100. For example, recommendation units 108 suggesting a viewing user invite new users to the social networking system 100 promote a goal of increasing the number of social networking system users. Recommendation units 108 suggesting a viewing user establish connections with other social networking system users advance a goal of increasing user interaction with the social networking system 100. In one embodiment, the social networking system 100 maintains a budget for a variety of goals, and different goals area associated with bids for recommendation units 108. The bid for a recommendation unit 108 associated with a goal is based on a value to the social networking system 100 of promoting the goal. Thus, each recommendation unit 108 is associated with bids associated with one or more goals of the social networking system that reflect the value to a goal of the social networking system 100 of the viewing user performing the action identified by the recommendation unit, or “converting” the recommendation unit into information for the social networking system 100. The bids are used to determine the expected value to the social networking system 100 of providing the advertisement to the viewing user. In the preceding examples, when the viewing user converts the recommendation units 108 into an action, the social networking system 100 obtains additional information about the viewing user, allowing it to more accurately identify content of interest to the viewing user, or obtain additional users for the social networking system 100, which advance goals of the social networking system 100.

The suggestion content 120 may also include one or more advertisements 112, which are content provided by one or more advertisers that compensate the social networking system 100 for presenting the advertisements 112 to the user. In one embodiment, an advertiser associates a bid amount with the advertisement 112 provided to the social networking system 100. The bid amount is used to determine the compensation received by the social networking system 100 if the advertisement 112 is presented to a user, such as the viewing user, or if the user interacts with the displayed advertisement 112. The bid amount is used to determine an expected value to the social networking system 100 of presenting the advertisement 112. For example, the bid amount of the advertisement 112 is multiplied by a probability of the advertisement being converted to determine the expected value of the advertisement. As another example, the bid amount acts as the expected value by specifying an amount of money the social networking system 100 receives from the advertiser if the advertisement 112 is displayed. Other advertisement valuation models may also be applied.

In various embodiments, the suggestion content 120 includes a limited amount of information. For example, the suggestion content 120 may include six “slots” in which content items selected from the recommendation units 108 and the advertisements 112 are displayed. The example suggestion content 120 shown by FIG. 1 includes three advertisements 112A, 112B, 112C and the three recommendation units, 108A, 108B, 108C. In one embodiment, the suggestion content 120 includes a specified number of the recommendation units 108 and a specified number of the advertisements 112. In the preceding example, the suggestion content 120 may include three recommendation units 108 and three advertisements 112. However, in other embodiments, the suggestion content 120 may include a variable number of the recommendation units 108 and a variable number of the advertisements 112, with at least one of each being included in the suggestion content 120.

Accordingly, the social networking system 100 selects recommendation units 108, and advertisements 112, for the suggestion content 120 that maximizes the benefit to the social networking system 100. The recommendation units 108 may be selected based on the bids associated with them by different goals, allowing presentation of the recommendation units 108 to be based on the ability of the recommendation units 108 to advance one or more of the goals. Hence, the expected value to various goals of the viewing user converting recommendation units 108 is used to identify the recommendation units 108 presented to the viewing user.

As described above, the recommendation units 108 are associated with one or more bids associated with the one or more goals of the social networking system 100 based on values associated with the one or more goals for the viewing user performing the recommended action identified by the recommendation unit, or “converting” the recommendation unit into information for the social networking system. Hence, the bids associated with a recommendation unit 108 are generated by the social networking system 100 representing the value to the social networking system 100 of converting the recommendation unit 108. As bids for a recommendation unit 108 may be associated with multiple goals, a combined bid for the recommendation unit 108 may be generated based on the bids associated with various goals, so the combined bid reflects the overall value of a recommendation unit 108 of a conversion of the recommendation unit 108. In contrast, the advertisements 112 are associated with an expected value based on a bid amount associated with the advertisements 112 by a single advertiser.

Associating bids from various goals with recommendation units 108 allows the social networking system 100 to promote a variety of goals and select recommendation units 108 for presentation to the viewing user that promote a combination of goals. As the social networking system 100 may associate budgets with the various goals, the social networking system 100 may also determine the amounts expended for promoting various goals relative to the budget specified for promoting the goal. In one embodiment, the advertisements and recommendation units compete against one another for slots in the suggestion content 120. Use of a unified ranking of advertisements 112 and recommendation units 108 is further described in U.S. patent application Ser. No. 13/549,080, filed on Jul. 13, 2012, which is hereby incorporated by reference herein in its entirety.

### Recommendation Unit Selection

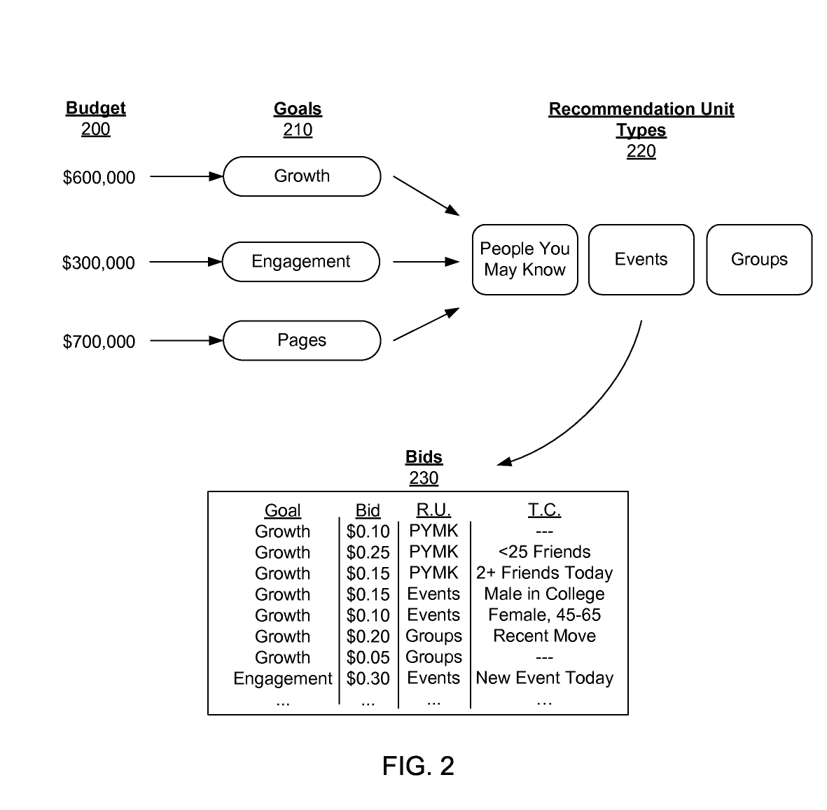

FIG. 2 is a block diagram of goal-specific bids for recommendation units. In the example of FIG. 2, the goal-specific bids are associated with types of recommendation units. The social networking system 100 allocates a budget 200 to various goals 210. For example, a budget 200 is allocated to goals of growth, user engagement, and page creation. Other examples of goals include interest identification, various types of user engagement, user retention, or other suitable interactions with the social networking system 100.

Based on their associated budgets, goals provide bids associated with various recommendation units. For example, a bid associated with a goal is associated with various types 220 of recommendation units; hence, a bid amount associated with a goal is placed for recommendation units having the type 220 specified by the bid associated with the goal. FIG. 2 shows “People You May Know” (PYMK), Events, and Groups as examples of types 220 of recommendation units. The bid associated with a goal 210 placed on a type of 220 recommendation unit includes a bid amount based on the extent to which the goal 210 is promoted by the type 220 of recommendation unit and on the value to the goal 210 of a user presented with the type 220 of recommendation unit converting the presented recommendation unit.

Bids associated with goals 210 may be associated with types 220 of recommendation units in various ways. In one embodiment, an operator of the social networking system 100 selects and places bids according to particular interests of the operator. For example, an operator may be responsible for promoting the growth goal and desire to enhance the participation of males in Germany between the ages of 35 and 55, so the operator places bids on types 220 of recommendation units likely to increase interactions with the social networking system 100 by this group of users. Alternatively, the social networking system 100 selects bid amounts and types 230 of recommendation unit based on a budget 200 associated with a goal 210 and identifying a target group of users. The type 230 of recommendation unit on which a bid associated with the goal is placed may be selected based on conversion rates of the group for types 230 of recommendation units and a bid amount in the bid may be selected as an so that the budget is evenly spent over a period of time.

Bids 230 on types 220 of recommendation units by various goals 210 are shown in FIG. 2 as associated with a goal, a bid amount, a type of recommendation units, and targeting criteria. In other embodiments, bids may include fewer and/or additional components. Targeting criteria are associated with a type 230 of recommendation unit and define characteristics of a user to be presented with a recommendation unit having the type. If a viewing user satisfies the targeting criteria, a recommendation unit having a type associated with the targeting criteria is eligible to be presented to the viewing user. The targeting criteria for a recommendation unit may include demographic information about the user, connections by the user to other users, actions associated with the user, or any other suitable information associated with the user by the social networking system 100. Examples of information associated with the user by the social networking system include: groups including the user, events attended by the user, content associated with the user, or other suitable data.

As shown in FIG. 2, bids 230 may include several bids from a goal for individual recommendation units. For example, in FIG. 2, the growth goal is associated with seven bids, three of which are for “people you may know” the recommendation unit type. The bid price for the recommendation units may be based on any suitable bidding metric, such as a per-impression, per-click, or per-conversion method for bidding. As recommendation units suggest specific actions for a user, such as adding a connection, conversions of a recommendation unit often occur near in time to presentation of the recommendation unit.

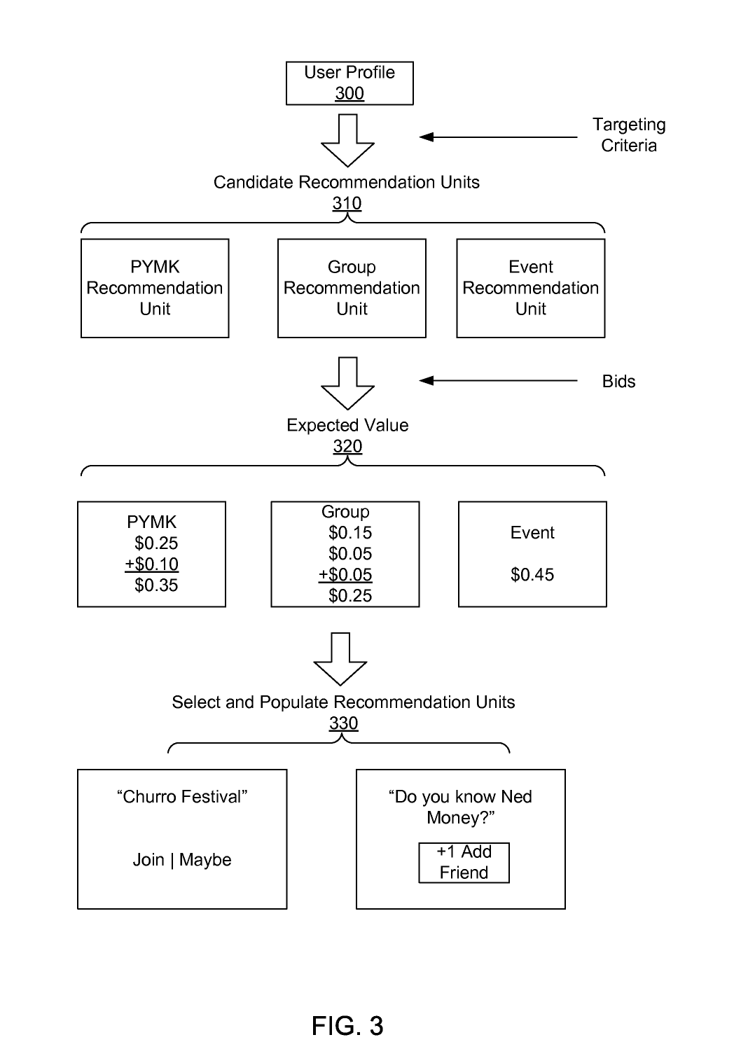

FIG. 3 is a block diagram of an embodiment of selecting recommendation units based on goal-specific bids. The social networking system identifies a user profile 300 associated with a viewing user accessing the social networking system. The user profile 300 includes information describing the viewing user. Examples of information included in a user profile 300 include information provided to the social networking system by the user, information associated with the user received from other users, information inferred about the user, or information about the user from any suitable source. Information associated with a user and maintained by the social networking system is further described below in conjunction with FIG. 5.

Based on the user profile 300, the social networking system applies targeting criteria associated with recommendation units or with types of recommendation units to identify candidate recommendation units 310 for presentation to the viewing user. If information in the viewing user's user profile 300 satisfies one or more targeting criteria associated with a recommendation unit or associated with a type of recommendation unit. In the example of FIG. 3, the user profile 300 includes information satisfying targeting criteria associated with three types of recommendation units, so recommendation units having these three types are identified as candidate recommendation units.

An expected value 320 for the candidate recommendation units 310 is determined based on the bids associated with various goals associated with the candidate recommendation units 310. In one embodiment, an expected value 320 is calculated for each candidate recommendation unit 310. A candidate recommendation unit's expected value is determined by combining bids associated with different goals that are associated with the candidate recommendation unit 310. For example, a combined bid amount for the candidate recommendation unit 310 is generated by summing the bids associated with different goals for the recommendation unit. In the example of FIG. 3, example, multiple goals are associated with bids of $0.25 and $0.10 for the PYMK recommendation unit. Similarly, the group recommendation unit is associated with bids from multiple goals of $0.15, $0.05, and $0.05. The event recommendation unit is associated with a bid associated with bid of $0.45 by a single goal. The individual bid amounts are combined to determine a combined bid amount. For example, the bids associated with multiple goals are summed, as described above. In some embodiments, the combined bid amount may be higher or lower than the sum of the bid amounts associated with different goals. For example, the combined bid amount may be increased from the sum of the bid amounts associated with goals by an increment to increase the likelihood that recommendation units promoting multiple goals are presented. The value of the increment may be allocated to an overall budget for recommendation units rather than a budget for a particular goal.

The expected value 320 of a candidate recommendation unit may also account for a likelihood of the viewing user converting the candidate recommendation unit into information. For example, the combined bid amount may be multiplied by a probability of conversion so that the expected value 320 of the candidate recommendation unit represents the likelihood of the viewing user interacting with the candidate recommendation unit. Other factors may be used to modify the combined bid amount to determine the expected value 320 of a candidate recommendation unit. In the example of FIG. 3, the expected value 320 of the candidate recommendation units is the combined bid amount.

Based on the expected values 320 of the candidate recommendation units, the candidate recommendation units are ranked, and one or more candidate recommendation units are selected 330 based on the ranking. For example, the expected values 320 are included in an auction that is used to select candidate recommendation units based on their expected values 320. In FIG. 3, two slots for recommendation units are available, and the event recommendation unit and the PYMK recommendation unit type, which have the highest combined bid amounts, are selected 330. A budged associated with a goal associated with a bid for a selected candidate recommendation unit is reduced by the bid amount associated with the goal. After selecting 330 the candidate recommendation units, information from the user profile 300 of the viewing user is retrieved and used to generate the content for the selected candidate recommendation units. For example, the PYMK recommendation unit identifies other users to which the viewing user is potentially connected, while the event recommendation unit identifies events in which the viewing user is likely to have an interest. The selected candidate recommendation units are then provided to the viewing user as suggestion content, further described above in conjunction with FIG. 1

### System Architecture

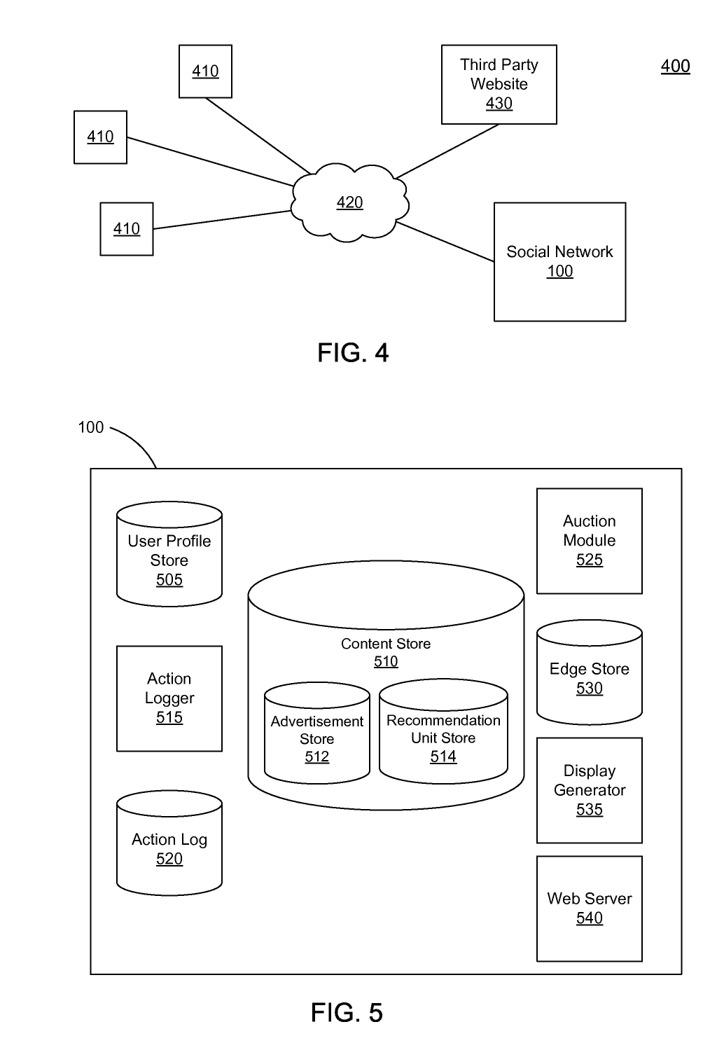

FIG. 4 is a high level block diagram illustrating a system environment 400 for the social networking system 100. The system environment 400 comprises one or more client devices 410, a network 420, one or more third-party websites 430 and the social networking system 100. In alternative configurations, different and/or additional components may be included in the system environment 400. The embodiments described herein can be adapted to online systems that are not social networking systems.

The client devices 410 comprise one or more computing devices capable of receiving user input as well as transmitting and/or receiving data via the network 420. In one embodiment, the client device 410 is a conventional computer system, such as a desktop or laptop computer. In another embodiment, a client device 410 may be a device having computer functionality, such as a personal digital assistant (PDA), mobile telephone, smart-phone, or similar device. The client device 410 is configured to communicate via the network 420. In one embodiment, a client device 410 executes an application allowing a user of the client device 410 to interact with the social networking system 100. For example, a client device 410 executes a browser application to enable interaction between the client device 410 and the social networking system 100 via the network 420. In another embodiment, a client device 410 interacts with the social networking system 100 through an application programming interface (API) that runs on the native operating system of the client device 410, such as iOS® or ANDROID™.

The client devices 410 are configured to communicate via the network 420, which may comprise any combination of local area and/or wide area networks, using both wired and wireless communication systems. In one embodiment, the network 420 uses standard communications technologies and/or protocols. Thus, the network 420 may include communication links using technologies such as Ethernet, 802.11, worldwide interoperability for microwave access (WiMAX), 3G, 4G, CDMA, digital subscriber line (DSL), etc. Similarly, the networking protocols used on the network 420 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over the network 420 may be represented using technologies and/or formats including hypertext markup language (HTML) or extensible markup language (XML). In addition, all or some of the communication links can be encrypted using conventional encryption technologies such as secure sockets layer (SSL), transport layer security (TLS), and Internet Protocol security (IPsec). The third party website 430 may be coupled to the network 420 for communicating with the social networking system 100, which is further described below in conjunction with FIG. 5.

FIG. 5 is an example block diagram of a system architecture of the social networking system 100. The social networking system 100 includes a user profile store 505, a content store 510, an action logger 515, an action log 520, an auction module 525, an edge store 530, a display generator 535, and a web server 540. In other embodiments, the social networking system 100 may include additional, fewer, or different modules for various applications. Conventional components such as network interfaces, security functions, load balancers, failover servers, management and network operations consoles, and the like are not shown so as to not obscure the details of the system architecture.

Each user of the social networking system 100 is associated with a user profile, which is stored in the user profile store 505. A user profile includes information about the user that was explicitly shared by the user, and may also include profile information inferred by the social networking system 100. In one embodiment, a user profile includes multiple data fields, each data field describing one or more attributes of the corresponding user of the social networking system 100. The user profile information stored in the user profile store 505 describes the users of the social networking system 100, including biographic, demographic, and other types of descriptive information, such as work experience, educational history, gender, hobbies or preferences, location, and the like. A user profile may also store other information provided by the user, for example, images or videos. In certain embodiments, images of users may be tagged with identification information of users of the social networking system 100 displayed in an image.

The content store 510 stores content items associated with a user profile, such as images, videos, and audio files. Content items from the content store 510 may be displayed when a user profile is viewed or when other content associated with the user profile is viewed. For example, displayed content items may show images or video associated with a user profile or show text describing a user's status. Additionally, other content items may facilitate user engagement by encouraging a user to expand his connections to other users, to invite new users to the system, or to increase interaction with the social networking system 100 by displaying content related to users, objects, activities, or functionalities of the social networking system. Examples of social networking content items include suggested connections or suggestions to perform other actions, media provided to, or maintained by, the social networking system 100 (e.g., pictures or videos), status messages or links posted by users to the social networking system, events, groups, pages (e.g., representing an organization or commercial entity), and any other content provided by or accessible via the social networking system.

In one embodiment, the content store 510 includes advertisements and recommendation units. For example, the content store 510 includes an advertisement store 512 that includes advertisements and a recommendation unit store 514 that includes recommendation units. An advertisement included in the advertisement store 512 includes content and a bid amount. The bid amount is associated with an advertisement by an advertiser and is used to determine an expected value, such as monetary compensation, provided by an advertiser to the social networking system 100 if the advertisement is presented to a user, if the advertisement receives a user interaction, or based on any other suitable condition. For example, the bid amount specifies a monetary amount that the social networking system 100 receives from the advertiser if the advertisement is displayed and the expected value is determined by multiplying the bid amount by a probability of the advertisement being accessed.

A recommendation unit in the recommendation unit store 514 includes content describing a suggested action for the user. Recommendation units are further described above in conjunction with FIG. 1. In one embodiment, the recommendation units are determined for a user when the user requests content from the social networking system 100. Alternatively, recommendation units are selected for the user before the user requests content from the social networking system 100. As described above in conjunction with FIGS. 2 and 3, a recommendation unit is associated with one or more bid amounts that are associated with goals of the social networking system 100.

The action logger 515 receives communications about user actions on and/or off the social networking system 100, and populates the action log 520 with information about user actions. Such actions may include, for example, adding a connection to another user, sending a message to another user, uploading an image, reading a message from another user, viewing content associated with another user, attending an event posted by another user, among others. In addition, a number of actions described in connection with other objects are directed at particular users, so these actions are associated with those users as well. These actions are stored in the action log 520.

Users may interact with various objects on the social networking system 100, including commenting on posts, sharing links, and checking-in to physical locations via a mobile device, accessing content items in a sequence, or other interactions. Information describing these actions is stored in the action log 520. Additional examples of interactions with objects on the social networking system 100 included in the action log 520 include commenting on a photo album, enabling communications between users, becoming a fan of a musician, adding an event to a calendar, joining a group, becoming a fan of a brand page, creating an event, authorizing an application, using an application, and engaging in a transaction. Additionally, the action log 520 records a user's interactions with recommendation units, advertisements on the social networking system 100, and other applications operating on the social networking system 100.

The auction module 525 selects content from the content store 510, such as advertisements and recommendation units for presentation to a user. In some embodiments, the auction module 525 may also select different and/or additional types of content from the content store 510. The auction module 525 retrieves advertisements from the advertisement store, retrieves data from the recommendation unit store 514, and generates recommendation units based on the retrieved data. The auction module 525 selects one or more recommendation units for presentation to a social networking system user. In one embodiment, the auction module 525 determines the combined bid amounts for recommendation units and generates expected values for the recommendation units based on the combined bid amounts. Using the expected values for recommendation units, the auction module 525 selects recommendation units for presentation to a user, as described above in conjunction with FIGS. 2 and 3. For example, the auction module 525 determines expected values for recommendation units based on bid amounts associated with recommendation units by various goals. This allows different goals of the social networking system to influence selection of recommendation units presented to users.

In other embodiments, the expected values are used in an auction process for different slots in the suggestion content where the content presented in a slot is the candidate advertisement or candidate recommendation unit having the highest expected value. In one embodiment, at least one slot in the suggestion content is designated for a recommendation unit and at least one slot in the suggestion content is designated for an advertisement. In some implementations of an auction process, an expected value may be modified by a quality metric reflecting the relevance of a candidate advertisement or recommendation unit, respectively, to one or more characteristics of the viewing user.

In one embodiment, an edge store 530 stores the information describing connections between users and other objects on the social networking system 100 in edge objects. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 100, by, for example, expressing interest in a page on the social networking system, sharing a link with other users of the social networking system, and commenting on posts made by other users of the social networking system. The edge store 530 stores edge objects that include information about the edge, such as affinity scores for objects, interests, and other users. Affinity scores may be computed by the social networking system 100 over time to approximate a user's affinity for an object, interest, and other users in the social networking system 100 based on the actions performed by the user. Multiple interactions between a user and a specific object may be stored in one edge object in the edge store 530, in one embodiment. In some embodiments, connections between users may be stored in the user profile store 505, or the user profile store 510 may access the edge store 530 to determine connections between users.

The display generator 535 determines when a social networking system user has requested information be displayed and retrieves content from the content store 510 for presentation to the social networking system user. The display generator 535 may also control the layout and format of the information displayed to the social networking system user. In one embodiment, the display generator 535 presents different types of content in different regions. For example, content describing actions taken by other users of the social networking system 100 connected to the user is displayed in a first region while other content, such as advertisements and recommendation units, are displayed in a second region. The display generator 535 also retrieves the one or more advertisements and the one or more recommendation units selected by the auction module 525 for presentation to a user.

In one embodiment, the display generator 535 organizes recommendation units and advertisements presented to a user as suggested content to increase the likelihood of the user interacting with the suggestion content. Increasing the likelihood of user interaction with recommendation units and/or advertisements also increases the value of the recommendation units and/or advertisements to the social networking system 100. For example, the display generator 535 organizes advertisements or recommendation units so the highest-value content is most prominently displayed or so the content most relevant to actions or characteristics of the user is most prominently displayed. In other examples, the display generator 535 displays advertisements and/or recommendation units to a user as a function of time, user status, user usage patterns, or other suitable user data.

The web server 540 links the social networking system 100 via the network 420 to the one or more client devices 410, as well as to the one or more third party websites 430. The web server 540 serves web pages, as well as other web-related content, such as JAVA®, FLASH®, XML and so forth. The web server 540 may provide the functionality of receiving and routing messages between the social networking system 100 and the client device 410, for example, instant messages, queued messages (e.g., email), text and SMS (short message service) messages, or messages sent using any other suitable messaging technique. A user may send a request to the web server 540 to upload information, for example, images or videos that are stored in the content store 510. Additionally, the web server 540 may provide API functionality to send data directly to native client device operating systems, such as IOS®, ANDROID™, WEBOS® or RIM.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer-readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer-readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving a request for content from a viewing user of a social networking system;
receiving a plurality of candidate recommendation units for the viewing user, each candidate recommendation unit including a recommendation that the viewing user perform an action in the social networking system identified by the recommendation unit;
determining a plurality of bid amounts for each candidate recommendation unit, each bid amount associated with a goal of the social networking system and based on a value to the goal of the viewing user performing the action identified by the candidate recommendation unit;
determining a combined bid amount for each candidate recommendation unit based on the plurality of bid amounts associated with a candidate recommendation unit;
determining an expected value for each candidate recommendation unit based on the combined bid amount associated with the candidate recommendation unit;
ranking the candidate recommendation units using the expected value;
selecting content for presentation to the viewing user including a recommendation unit selected from the candidate recommendation units based at least in part on the ranking; and
sending the selected content for display to the viewing user.

2. The computer-implemented method of claim 1, wherein the combined bid amount for the candidate recommendation unit is a sum of the plurality of bid amounts for the candidate recommendation unit.

3. The computer-implemented method of claim 1, wherein the expected value of the candidate recommendation unit is based on the combined bid amount associated with the candidate recommendation unit and a likelihood the viewing user interacts with the candidate recommendation unit.

4. The computer-implemented method of claim 1, wherein the expected value of the candidate recommendation unit is the combined bid amount associated with the candidate recommendation unit.

5. The computer-implemented method of claim 1, wherein the bid amount associated with a goal is based on social networking information associated with the viewing user.

6. The computer-implemented method of claim 1, wherein the combined bid amount is measured in currency.

7. The computer-implemented method of claim 1, further comprising:
reducing a budget associated with a goal associated the recommendation unit selected from the candidate recommendation units by the bid amount for the recommendation unit selected from the candidate recommendation units associated with the goal.

8. The computer-implemented method of claim 1, further comprising
retrieving a plurality of candidate advertisements for the viewing user, each candidate advertisement associated with a bid amount;
determining an expected value for each of the plurality of candidate advertisements;
ranking the candidate recommendation units and the candidate advertisements based on the expected values; and
selecting at least one candidate recommendation unit and at least on candidate advertisement based on the ranking.

8. A computer-implemented method comprising:
storing a budget for each of a plurality of goals of a social networking system;
receiving a request for content from a viewing user of the social networking system;
receiving a plurality of candidate recommendation units for the viewing user, each candidate recommendation unit including a recommendation that the viewing user perform an action in the social networking system identified by the recommendation unit;
determining a plurality of bid amounts for each candidate recommendation unit, each bid amount associated with a goal of the social networking system and based on a value to the goal of the viewing user performing the action identified by the candidate recommendation unit;
determining an expected value for each candidate recommendation unit based on the plurality of bid amounts associated with a candidate recommendation unit;
ranking the candidate recommendation units using the expected value;
selecting a recommendation unit from the candidate recommendation units based at least in part on the ranking, the selected recommendation unit associated with bid amounts associated with one or more goals;
reducing a budget associated with a goal associated with a bid amount associated with the selected recommendation unit by the bid amount associated with the selected recommendation unit; and
sending content including the selected recommendation unit for display to the viewing user.

9. The computer-implemented method of claim 8, wherein an expected value of a candidate recommendation unit is a sum of the plurality of bid amounts associated with the candidate recommendation unit.

10. The computer-implemented method of claim 8, wherein an expected value of a candidate recommendation unit based on a sum of the plurality of bid amounts associated with the candidate recommendation unit and a likelihood the viewing user interacts with the candidate recommendation unit.

11. The computer-implemented method of claim 8, wherein an expected value of a candidate recommendation unit is a sum of the plurality of bid amounts associated with the candidate recommendation unit modified by an increment.

12. The computer-implemented method of claim 1, wherein a bid amount associated with a goal is based on social networking information associated with the viewing user.
